(19) United States
(12) Patent Application Publication
(10) Pub. No.: US 2018/0203981 A1
(43) Pub. Date: Jul. 19, 2018

(54) Data Containerization using Rights Management techniques

(71) Applicant: Vaultize Technologies Private Limited, Pune (IN)

(72) Inventors: Ankur Panchbudhe, Pune (IN); Praneeth Siva, Pune (IN); Amol Vaikar, Pune (IN); Yusuf Batterywala, Pune (IN)

(73) Assignee: Vaultize Technologies Private Limited, Pune (IN)

(21) Appl. No.: 15/918,949

(22) Filed: Mar. 12, 2018

(51) Int. Cl. G06F 21/10; G06F 9/455; G06F 21/60

(52) U.S. Cl. CPC G06F 21/105; G06F 21/604; G06F 9/455

(57) ABSTRACT

Embodiments herein disclose a method and system for performing data containerization using rights management techniques. Embodiments herein disclose a method and system for containerizing data using information rights management, wherein the rights management associates a plurality of sets of rules with each of the data present in the data containers. The sets of rules are applied based on a plurality of factors such as if the data is present within a data container, the device being used to access the data and so on.

### TECHNICAL FIELD

The embodiments herein relate to data management and, more particularly, to performing data management by containerizing the data.

### BACKGROUND

Data management is one of the prime areas of concern of the modern world. The term ‘data management’ does not just address way of organizing data, but also focuses on data security aspects. With the increasing popularity of ‘Bring Your own Device (BYOD)’ trend, which allows users to use their personal device for professional/official use as well, data security concerns are at peak. BYOD allow users to access data belonging to the enterprise, which is of confidential nature, from any location. There is a need to keep corporate data separate from personal data and also to make sure that corporate data does not get leaked or lost just because the company does not own the device. Further, the personal devices of users may not possess sufficient security means to fight malware and similar fraudulent attacks, which poses high data security risk.

Data containerization is a technique/mechanism, which is used to protect data of the confidential nature, from unauthorized access. This may involve locking down the data to be protected, and providing access to a user only after a successful authentication check. In data containerization, there can be a plurality of data containers such as a corporate data container, a personal data container and so on. These containers are typically folders or databases, with each holding a particular kind of data with particular set of rights and rules.

Data containerization is typically achieved by controlling the movement of files in and out of individual container folders. So typically, files are not allowed to be moved or be copied from corporate container to personal container, but vice-versa can be permitted. The problem with such approaches, which are typically implemented using techniques like virtual folders or file-system drivers, is that they can be easily bypassed by using system-level or third party tools or by using techniques like copy-paste and screenshots.

### BRIEF DESCRIPTION OF THE FIGURES

The embodiments herein will be better understood from the following detailed description with reference to the drawings, in which:

FIGS. 1a, 1b, 1c, 1d and 1e depict systems for containerizing data using rights management, according to embodiments as disclosed herein;

FIG. 2 is a flowchart representing the process of applying RM to data in a data container, according to embodiments as disclosed herein; and

FIG. 3 is a flowchart representing the process of enforcing RM on data, according to embodiments as disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

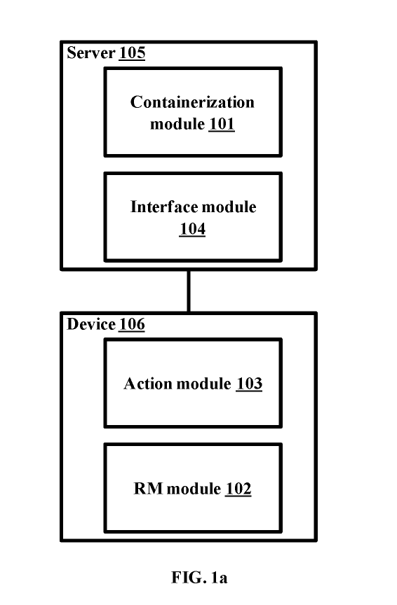

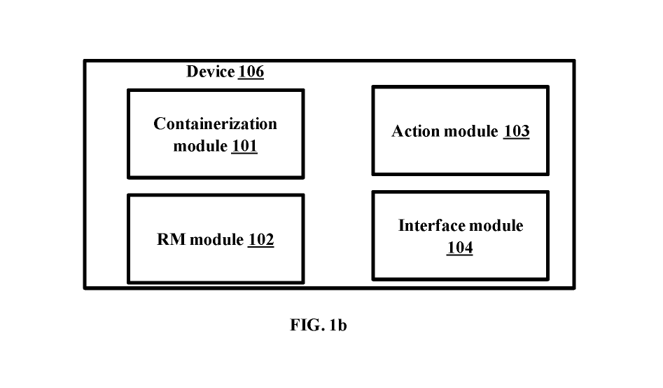

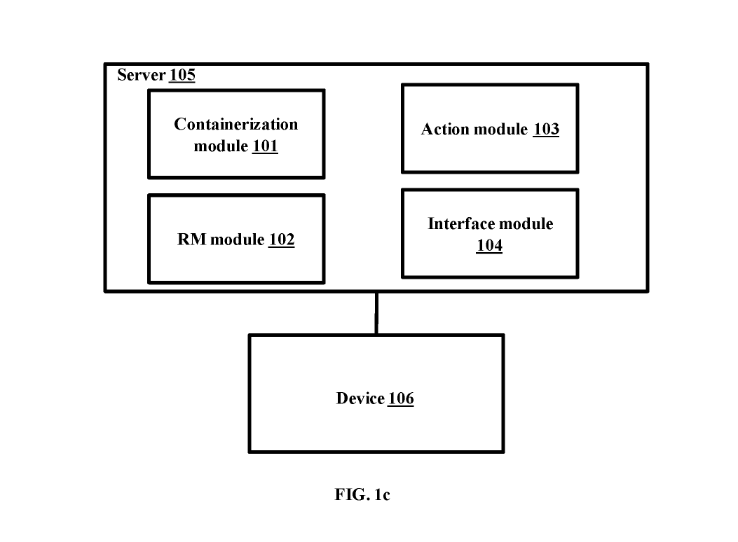

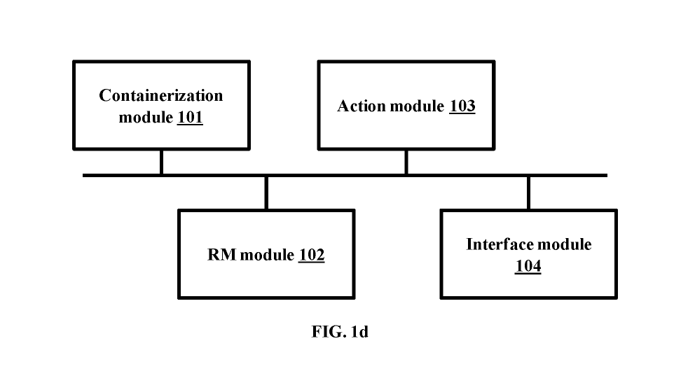

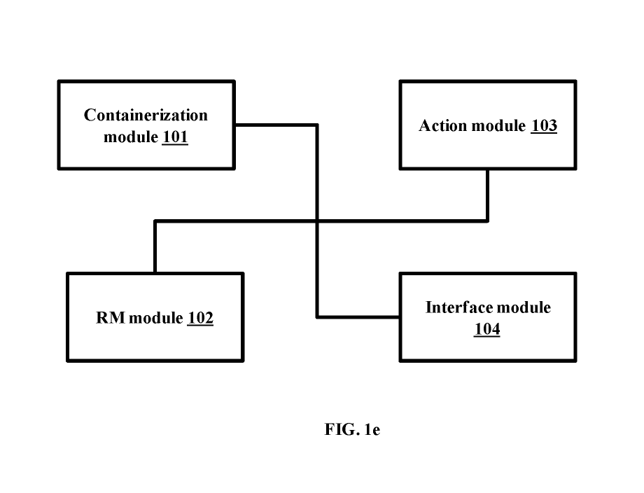

The embodiments herein disclose methods and systems for performing data containerization using rights management techniques. Referring now to the drawings, and more particularly to FIGS. 1 through 3, where similar reference characters denote corresponding features consistently throughout the figures, there are shown embodiments.

Information rights management (IRM) (also referred to as E-DRM or Enterprise Digital Rights Management) is a subset of digital rights management (DRM), which can be used for protecting data from unauthorized access. IRM enables data to be ‘remote controlled’. IRM enables information and its control to be separately created, viewed, edited and distributed.

Data containerization refers to creating an encrypted data store (i.e., container) on a device or within an application. A container is not simply an encrypted file; for example, access to data in the container requires secure authentication independent of any other device settings or restriction. On a device with no unlock pass-code, no whole device encryption, and no security policies of any type, the contents of the container remain inaccessible unless an authorized user enters valid credentials (for example, a password or a username-password combination). Securing data in a container also allows an administrator to wipe official data from a personal device without wiping any personal data or applications by simply deleting the container. Rather than making sure the entire device is secure, which can limit the end-user from being able to use a smart phone or tablet to its full potential, the containerization creates a compartment within the device, where the corporate data and applications are segregated from the user's other applications and data.

Embodiments herein disclose methods and systems for containerizing data using information or digital rights management, wherein the rights management associates a plurality of sets of rules with each of the data present in the data containers. The sets of rules are applied based on a plurality of factors such as if the data is present within a data container, the device being used to access the data and so on.

FIGS. 1a, 1b, 1c, 1d and 1e depict systems for containerizing data using rights management, according to embodiments as disclosed herein. The system comprises of a containerization module 101, a Rights Management (RM) module 102, an action module 103, and an interface 104.

In FIG. 1a, the containerization module 101 and the interface 104 are present in a server 105 and the RM module 102 and the action module 103 are present in a device 106. In FIG. 1b, the containerization module 101, the interface 104, the RM module 102 and the action module 103 are present in a device 106. In FIG. 1c, the containerization module 101, the interface 104, the RM module 102 and the action module 103 are present in a server 105, wherein the server is connected to at least one device 106. In FIGS. 1d and 1e, the containerization module 101, the interface 104, the RM module 102 and the action module 103 are running on separate devices and are connected to each other using a network. In an embodiment herein, the network can be a peer-to-peer network.

The server 105 and the device 106 are connected to at least one source of data. The source of data can be a database, a file-system, a memory, the cloud, and so on. The database can be co-located with the server 105. The database can be located remotely from the server 105 and connected to the server 105 using a suitable means such as a wired and/or wireless link. The memory can be located internal to the device 106 and can be an inbuilt memory and/or an expandable memory. The memory can be located on another device, wherein the server 105 and/or the device 106 have access to the memory.

The device 106 can be at least one of a computer, a laptop, a tablet, a mobile device, a wearable computing device, a file server, a database server, a content management server, an Internet of Things (IoT) device, or any other device which will enable a user of the device 106 to access data, containerize data, and so on. The device 106 can be a part of a network belonging to the enterprise. The device 106 can also be a device, present external to the network belonging to the enterprise. The enterprise herein can be defined as an organization with a communication network, a plurality of individuals and/or organizations who use a communication network for data access, communication and so on.

The interface module 104 can enable a user of the device 106 or a user of the server 105 to access the data. The interface module 104 can enable the user to define data containers, wherein the devices where the data containers are located are referred to as container devices herein. The container device can be at least one of a separate device on which the data is originally present, a separate device from the device used by the user to access the data, the same device on which the data is originally present, the same device used by the user to access the data and so on. The interface module 104 can enable the user to define at least one right and/or rule associated with the data container. The interface module 104 can enable the user to define at least one right and rule associated with each piece of data (such as a file, an email, a mailbox, messages, objects, data blocks, data chunks, lists, contacts, calendar entries, and so on) present in the data container. The rights may comprise of open the data, view the data, edit the data, share the data, export the data, print the data, take screenshots of the data, cut contents of the data, copy contents of the data, paste contents into the data, delete the data, wipe the data, and so on. The rules can be based on attributes like device parameters (e.g. MAC (Media Access Controller) address, device name, and so on), user attributes (for example, user name, domain, email address, and so on), network parameters (e.g. IP (Internet Protocol) address, Wi-Fi, mobile communication network addresses and so on), geo-location, and so on. The rules can also comprise of a corresponding action component, which specifies what actions to take if at least one right is violated or fails. Examples of actions are: delete the data, encrypt the data, lock-down the data, hide the data, move the data, send a notification/email, raise an alert, and so on.

The interface module 104 can enable the user to define a plurality of sets of rights and/or rules. The interface module 104 can enable the user to define a first set of right(s) and/or rule(s), wherein these first set of rights are to be applied when the data is inside the data container. The interface module 104 can enable the user to define a second set of right(s) and/or rule(s), wherein these second set of right(s) and/or rule(s) are to be applied when the data (that was originally present inside the data container) is outside the container. The interface module 104 can enable the user to define a third set of right(s) and/or rule(s), wherein these third set of right(s) and/or rule(s) are to be applied to the data, when the data (wherein the data can be present inside the container or the data is present outside the container and was originally present inside the container) is accessed on a device different from the container device. The three sets of rules are used here for purposes of examples, and it may be obvious to a person of ordinary skill in the art to define further sets of rules and rights based on at least one other condition. The interface module 104 parses the definitions of data containers and associated rights and rules, received from the user in the form of inputs. The interface module 104 communicates the parsed inputs to the containerization module 101.

The containerization module 101 can maintain (store, process, interpret and so on) the definitions of data containers as well as the rights and rules associated with the data containers, as received from the interface module 104. On receiving the inputs from the interface module 101, the containerization module 101 can create the data containers by accessing the location where the data is stored (if not already created). The containerization module 101 can then provide the information about the created data containers to the RM module 102. The containerization module 101 can also provide information about rights and rules to the RM module 102. The containerization module 101 can provide information to the RM module 102 based on factors such as device/server on which DRM/IRM module is running, type of container, type of rights/rules and so on. The containerization module 101 can provide information about the data containers and associated rights and rules to the RM module 102 at pre-defined intervals, as defined by an administrator. The containerization module 101 can provide information about the data containers and associated rights and rules to the RM module 102 in real-time. The containerization module 101 can provide information about the data containers and associated rights and rules to the RM module 102 on a specific event occurring, such as a data container being created/updated, rights and/or rules being created/updated and so on. The containerization module 101 can also store the information about the data container and associated rights and rules in a suitable data storage location.

On receiving the information about the data containers and the associated rights and rules from the containerization module 101, the RM module 102 can apply rights management to the data inside the data container, based on the provided rights and rules. In an embodiment herein, the RM module 102 can pull the information about the data containers and the associated rights and rules from the containerization module 101, at pre-defined intervals. In an embodiment herein, the RM module 102 can pull the information about the data containers and the associated rights and rules from the containerization module 101 in real-time. In an embodiment herein, the RM module 102 can pull the information about the data containers and the associated rights and rules from the containerization module 101 on a specific event occurring, such as a data container being created/updated, rights and/or rules being created/updated and so on. The rights management can apply a plurality of sets of rights and rules to the data. In an example herein, the RM module 102 can encrypt the data using DRM (Digital Rights Management). The RM module 102 can monitor the data containers for new and/or updated data, either directly or using indications provided by the containerization module 101. On detecting updated data, the RM module 102 can apply rights management to the new and/or updated data. On applying the rights management to the data, the RM module 102 can capture identity of the data container and identity of the source device (which can be in the form of a MAC address, an IP address or any other equivalent identification means). On capturing the identities, the RM module 102 can store the captured identities inside the data. In an embodiment herein, the RM module 102 can store the rights and rules inside the data. In an embodiment herein, the RM module 102 can store the rights and rules in a suitable data storage location.

The RM module 102 can monitor the data container to check if a user is accessing the data. The user can access the data, when the data is present in the data container using a device present in the network of the enterprise. The user can access the data, when the data is present in the data container using a device not present in the network of the enterprise. The user can access the data, when the data is present outside the data container using a device present in the network of the enterprise. The user can access the data, when the data is present outside the data container using a device not present in the network of the enterprise. The user can access the data directly (by performing an action such as double-clicking the data or any other equivalent means). The user can access the data using an application enabled to access the data (in an example, if the data is a mailbox, the user can access the data using a mail client, and so on).

On detecting that a user is attempting to access data, the RM module 102 can check if the current location of the data is inside the container or outside of the container. The RM module 102 can further check if the device being used for accessing the data is present inside the network of the enterprise or outside the network of the enterprise. If the data is present in the data container, the RM module 102 can retrieve the first set of rules and rights (either from within the data, the containerization module 101 or the data storage location where the RM module 102 stored the rules and rights) and enforce the first set of rights and rules. If the data is present outside the data container, the RM module 102 can retrieve the second set of rules and rights (either from within the data, the containerization module 101 or the data storage location where the RM module 102 stored the rules and rights) and enforce the second set of rights and rules. If the data is not on the container device, the RM module 102 can retrieve the third set of rules and rights (either from within the data, the containerization module 101 or the data storage location where the RM module 102 stored the rules and rights) and enforce the third set of rights and rules.

In an example, the first set of rights could be “allow view, edit and paste; but don't allow cut, copy, screenshot, print, export or share” and the second and third set of rights could be “reject all use”. So, when a file is inside it's container folder, the RM module 102 can enable the file to be viewed, edited or contents pasted into the file, but the RM module 102 ensures that the contents of the file cannot be cut, copied, screenshot, exported, printed or shared. Now, if the file is copied or moved outside the container (to another folder or device), the RM module 102 disables the file from opening because of the second and third set of rights.

Based on the rights and rules, if an action needs to be taken related to the data, the RM module 102 can provide an indication to the action module 103, either directly or through the containerization module 101. For example, a rule could be that if second or third set of rights and rules are violated, then the RM module 102 can instruct the action module 103 to delete, (securely) wipe or lock-down the data. In a second example, if the data is accessed from a removable device (e.g. USB pen drive or external disk), then the RM module 102 disables opening of the data and instructs the action module 103 to send an email to original owner of the data with details of the attempted access.

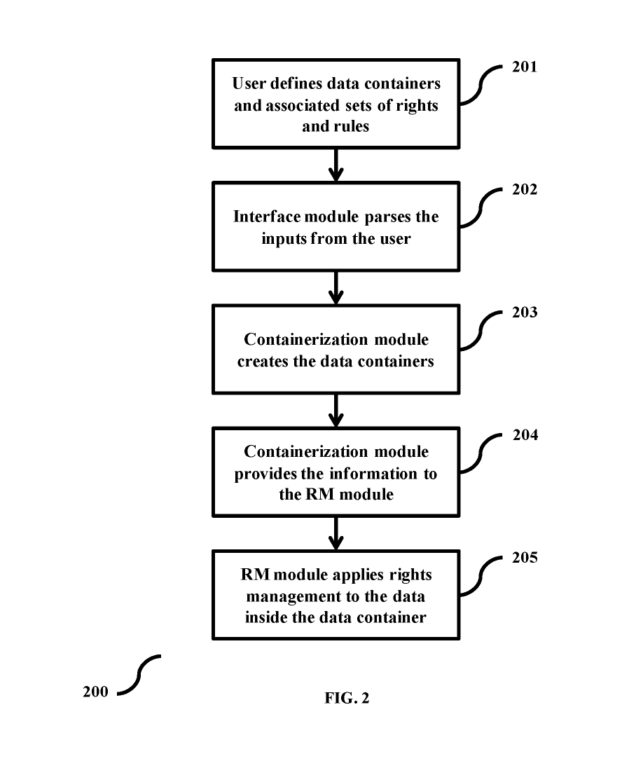

FIG. 2 is a flowchart representing the process of applying RM to data in a data container, according to embodiments as disclosed herein. The interface module 104 enables (201) a user of the device 106 or server 105 to define data containers and a plurality of sets of rights and rules associated with the data containers. The first set of right(s) and/or rule(s) are to be applied, when the data is present inside the data container. The second set of right(s) and/or rule(s) are to be applied when the data (that was originally present inside the data container) is outside the container. The third set of right(s) and/or rule(s) are to be applied to the data, when the data is accessed on a device different from the container device. The interface module 104 parses (202) the definitions of data containers and associated rights and rules, received from the user in the form of inputs. On receiving the parsed inputs from the interface module 104, the containerization module 101 creates (203) the data containers by accessing the location where the data is stored. The containerization module 101 then provides (204) the information about the created data containers and rights and rules to the RM module 102. On receiving the information about the data containers and the associated rights and rules from the containerization module 101, the RM module 102 applies (205) rights management to the data inside the data container, based on the provided rights and rules. The various actions in method 200 may be performed in the order presented, in a different order or simultaneously. Further, in some embodiments, some actions listed in FIG. 2 may be omitted.

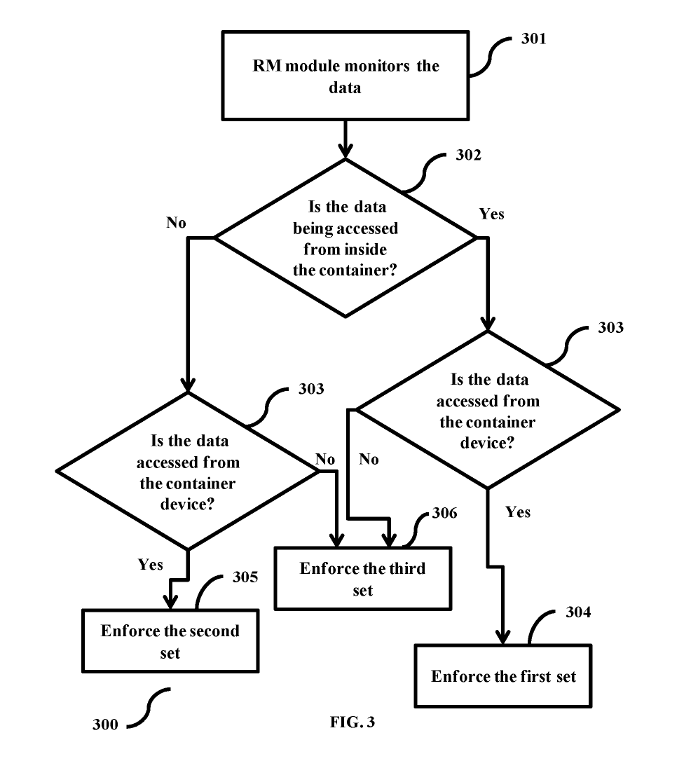

FIG. 3 is a flowchart representing the process of enforcing RM on data, according to embodiments as disclosed herein. The RM module 102 monitors (301) the data container to check if a user is accessing the data. On detecting that a user is attempting to access data, the RM module 102 checks (302) if the data is inside the container or outside of the container. The RM module 102 further checks (303) if the device on which data is being accessed is the container device or not. If the data is present inside the data container, the RM module 102 retrieves the first set of rules and rights and enforces (304) the first set of rights and rules. If the data is present outside the data container, the RM module 102 retrieves the second set of rules and rights and enforces (305) the second set of rights and rules. If the data is present on a device different from container device, the RM module 102 retrieves the third set of rules and rights and enforces (306) the third set of rights and rules. The various actions in method 300 may be performed in the order presented, in a different order or simultaneously. Further, in some embodiments, some actions listed in FIG. 3 may be omitted.

By using RM for containerization, embodiments herein are ensuring that the rights and rules are always enforced and data will always be containerized, because all designated data will be RM-encrypted and cannot be used without the RM module 102. Embodiments herein achieve containerization by having the second (and possibly third) set of rights/rules for RM.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

We claim:

1. A method for creating data containers, the method comprising
applying rights management to data associated with a data container by a Rights Management (RM) module, based on a plurality of sets comprising of at least one right and at least one rule, wherein the plurality of sets are enforced on the data based on whether the data is present inside or outside the data container.

2. The method, as claimed in claim 1, wherein the plurality of sets comprises of at least one action corresponding to a rule.

3. The method, as claimed in claim 1, wherein the method further comprises of the RM module applying rights management to new or updated data present in the data container.

4. The method, as claimed in claim 1, wherein the method further comprises of applying the plurality of sets based on whether the data is present in the container or not.

5. A method for managing a data container, the method comprising
enforcing at least one set comprising of at least one right and at least one rule on data associated with the data container by a Rights Management (RM) module, on a user accessing the data, wherein the RM module enforces the set of rules and rights based on whether the data is present inside or outside the data container; and
whether the data is present on the data container device or not.

6. The method, as claimed in claim 5, wherein the plurality of sets comprises of at least one action corresponding to a rule.

7. The method, as claimed in claim 5, wherein the method further comprises of enforcing the plurality of sets based on whether the data is present in the container or not.

8. A system for creating data containers, the system configured for
applying rights management to data associated with a data container, based on a plurality of sets comprising of at least one right and at least one rule, wherein the plurality of sets are enforced on the data based on whether the data is present inside or outside the data container.

9. The system, as claimed in claim 8, wherein the plurality of sets comprises of at least one action corresponding to a rule.

10. The system, as claimed in claim 8, wherein the system is further configured for applying rights management to new or updated data present in the data container.

11. The system, as claimed in claim 8, wherein the system is further configured for applying the plurality of sets based on whether the data is present in the container or not.

12. A system for managing a data container, the system configured for
enforcing at least one set comprising of at least one right and at least one rule on data associated with the data container, on a user accessing the data, wherein the system enforces the set of rules and rights based on whether the data is present inside or outside the data container; and
whether the data is present on the data container device or not.

13. The system, as claimed in claim 12, wherein the plurality of sets comprises of at least one action corresponding to a rule.

14. The system, as claimed in claim 12, wherein the system is further configured for enforcing the plurality of sets based on whether the data is present in the container or not.
